(19) United States
(12) Patent Application Publication
(10) Pub. No.: US 2023/0278552 A1
(43) Pub. Date: Sep. 7, 2023

(54) DRIVER ASSISTANCE SYSTEM AND DRIVER ASSISTANCE METHOD

(71) Applicant: HL KLEMOVE CORP., Incheon (KR)

(72) Inventor: HyunSoo PARK, Seoul (KR)

(21) Appl. No.: 18/116,827

(22) Filed: Mar. 2, 2023

(30) Foreign Application Priority Data
Mar. 2, 2022 (KR) 10-2022-0026889

(51) Int. Cl. B60W 30/095; B60W 30/14; B60W 50/14

(52) U.S. Cl. CPC B60W 30/0953; B60W 30/0956; B60W 30/143; B60W 50/14; B60W 2520/14; B60W 2050/143; B60W 2050/146; B60W 2540/12

(57) ABSTRACT

Disclosed is a driver assistance system that includes an obstacle detector, a lane detector, a speed detector, a yaw rate detector, and a controller configured to acquire a yaw rate value and a yaw acceleration value on the basis of the yaw rate information while performing a cruise control, determine whether the vehicle is in a turning state on the basis of the acquired yaw rate value and yaw acceleration value and the detected lane information, and control acceleration of the vehicle on the basis of the obstacle information and the actual traveling speed information when it is determined that the vehicle is in the turning state.

### CROSS-REFERENCE TO RELATED APPLICATION

This application claims the benefit of Korean Patent Application No. 10-2022-0026889, filed on Mar. 2, 2022 in the Korean Intellectual Property Office, the disclosure of which is incorporated herein by reference.

### BACKGROUND

### 1. Field

Embodiments of the present disclosure relate to a driver assistance system and a vehicle having the same, and more specifically, to a driver assistance system for limiting sudden acceleration on a road such as an intersection while a cruise control mode is performed and a vehicle having the same.

### 2. Description of the Related Art

Recently, various advanced driver assistance systems (ADASs) are being developed for autonomous traveling that transmits traveling information of a vehicle to a driver in order to prevent accidents caused by driver carelessness and also provides convenience to the driver.

As one example, there is a technology in which a distance detection sensor is mounted on a vehicle to detect an obstacle around the vehicle and alert the driver of the obstacle.

As another example, there is a cruise control technology of allowing a vehicle to travel while constantly adjusting a traveling speed. Recently, with the development of technology, a cruise control technology of not only automatically controlling the traveling speed, but also controlling a distance from another vehicle, stopping, and slowing is being developed.

As still another example, there is an autonomous traveling technology of allowing a vehicle to autonomously travel to a destination on the basis of road information and current position information, detect an obstacle, and autonomously travel to the destination while avoiding the detected obstacle.

The cruise control technology or the autonomous traveling technology recognizes a situation in front of a vehicle using an obstacle sensor and the like, and adjusts a traveling speed and a distance between vehicles without a driver's intervention by operating an engine or a brake according to the recognized front situation.

In other words, when predicting traveling situations of the vehicles, the conventional cruise control technology or autonomous traveling technology recognizes a preceding vehicle that travels in front of a host vehicle through the obstacle sensor, then follows the preceding vehicle, and adjusts the distance between the vehicles and the traveling speed.

The cruise control or autonomous traveling technology controls acceleration in response to the sudden departure of the preceding vehicle from a traveling route, and at this time, when the preceding vehicle is not departed from the traveling route like the turning at the intersection but it is incorrectly determined that the preceding vehicle moves away from the front of the host vehicle and is departed from the route, a problem that sudden acceleration occurs or the host vehicle collides with another vehicle that travels in front of the host vehicle occurs. In addition, the cruise control or autonomous traveling technology has a problem that the vehicle collides with the preceding vehicle when the preceding vehicle suddenly brakes.

### SUMMARY

Therefore, it is an aspect of the present disclosure to provide a driver assistance system for limiting sudden acceleration on a road such as an intersection while a cruise control mode is performed and a vehicle having the same.

Additional aspects of the disclosure will be set forth in part in the description which follows and, in part, will be obvious from the description, or may be learned by practice of the disclosure.

In accordance with one aspect of the present disclosure, a driver assistance system may include an obstacle detector configured to detect a nearby obstacle and output obstacle information on the detected obstacle, a lane detector configured to detect nearby lanes and output lane information on the detected lanes, a speed detector configured to detect a traveling speed of the vehicle and output actual traveling speed information on the detected traveling speed, a yaw rate detector configured to detect a yaw rate of the vehicle and output yaw rate information on the detected yaw rate, and a controller configured to acquire a yaw rate value and a yaw acceleration value on the basis of the yaw rate information while performing a cruise control, determine whether the vehicle is in a turning state on the basis of the acquired yaw rate value and yaw acceleration value and the detected lane information, and control acceleration of the vehicle on the basis of the obstacle information and the actual traveling speed information when it is determined that the vehicle is in the turning state.

The controller may derive each of a first offset between the vehicle and a left lane and a second offset between the vehicle and a right lane on the basis of the detected lane information, and determine whether the vehicle is in the turning state on the basis of a difference between the first offset and the second offset.

The controller may determine whether a following target vehicle is present around the vehicle on the basis of the obstacle information, and when it is determined that the following target vehicle is not present around the vehicle, control acceleration after whether an acceleration limit condition is satisfied is determined on the basis of the traveling speed information.

The acceleration limit condition may include a condition in which the traveling speed of the vehicle exceeds a first reference traveling speed and is lower than a second reference traveling speed.

The controller may control acceleration on the basis of an acceleration limit when it is determined that the acceleration limit condition is satisfied, and control the acceleration on the basis of preset cruise control acceleration when it is determined that the acceleration limit condition is not satisfied.

The acceleration limit may be determined on the basis of a difference between a speed of the vehicle and a speed of another vehicle that travels around the vehicle detected on the basis of the obstacle information.

The driver assistance system may further include a lever signal receiver configured to receive a lever signal of a traveling direction signal lever, the controller may further determine whether the vehicle is in the turning state on the basis of whether a turning command is received through the lever signal receiver.

The controller may determine that the turning command has been received when it is determined that any one traveling direction signal lamp has been turned on, and determine that an emergency lamp has been turned on when it is determined that two traveling direction signal lamps have been both turned on.

The controller may control at least one of a display device, a cluster, and a sound output device to output deceleration request information when controlling the acceleration of the vehicle.

The controller may control release of a cruise control mode when receiving pressure information corresponding to pressing of a brake pedal.

In accordance with another aspect of the present disclosure, a driver assistance method may include acquiring a yaw rate value and a yaw acceleration value on the basis of yaw rate information detected by a yaw rate detector of a vehicle while a cruise control is performed, determining whether the vehicle is in a turning state on the basis of the acquired yaw rate value and yaw acceleration value and lane information detected by a lane detector of the vehicle, and controlling acceleration of the vehicle on the basis of obstacle information detected by an obstacle detector of the vehicle and actual traveling speed information of the vehicle detected by a speed detector of the vehicle when it is determined that the vehicle is in the turning state.

The determining of whether the vehicle is in the turning state may include deriving each of a first offset between the vehicle and a left lane and a second offset between the vehicle and a right lane on the basis of the detected lane information and determining whether the vehicle is in the turning state on the basis of a difference between the first offset and the second offset.

The controlling of the acceleration of the vehicle may include determining whether a following target vehicle is present around the vehicle on the basis of the obstacle information and when it is determined that the following target vehicle is not present around the vehicle, controlling the acceleration of the vehicle after whether an acceleration limit condition is satisfied is determined on the basis of the traveling speed information.

The acceleration limit condition may include a condition in which a traveling speed of the vehicle exceeds a first reference traveling speed and is lower than a second reference traveling speed.

The controlling of the acceleration of the vehicle may include controlling the acceleration on the basis of an acceleration limit when it is determined that the acceleration limit condition is satisfied and controlling the acceleration on the basis of preset cruise control acceleration when it is determined that the acceleration limit condition is not satisfied.

The acceleration limit may be determined on the basis of a difference between a speed of the vehicle and a speed of another vehicle that travels around the vehicle detected on the basis of the obstacle information.

The determining of whether the vehicle is in the turning state may further include determining whether the vehicle is in the turning state on the basis of whether a turning command has been received through a lever signal receiver configured to receive a lever signal of a traveling direction signal lever.

The determining of whether the vehicle is in the turning state may include determining that the turning command has been received when it is determined that any one traveling direction signal lamp has been turned on and determining that an emergency lamp has been turned on when it is determined that two traveling direction signal lamps have been both turned on.

The controlling of the acceleration of the vehicle may include controlling at least one of a display device, a cluster, and a sound output device to output deceleration request information when controlling the acceleration of the vehicle.

The driver assistance method may further include controlling release of a cruise control mode when pressure information corresponding to pressing of a brake pedal is received.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a configuration diagram of a vehicle according to an embodiment;

FIG. 2 is a configuration diagram of a driver assistance system provided in the vehicle according to the embodiment;

FIG. 3 is a view schematically showing a camera and radar of the driver assistance system according to the embodiment;

FIG. 4 is a configuration diagram of a cruise control device of the driver assistance system provided in the vehicle according to the embodiment;

FIG. 5 is a vehicle control flowchart of the driver assistance system according to the embodiment;

FIG. 6 is a vehicle control flowchart of the driver assistance system according to the embodiment and is a vehicle control flowchart when determining whether the vehicle is in a turning state;

FIG. 7 is an output graph of a yaw rate when the vehicle according to the embodiment turns in a cruise control mode;

FIG. 8 is an exemplary view of a road environment when a vehicle according to an embodiment travels in the cruise control mode; and

FIG. 9 is an exemplary view of a road environment when a vehicle according to an embodiment travels in the cruise control mode.

### DETAILED DESCRIPTION

The same reference numbers indicate the same components throughout the specification. The specification does not describe all elements of embodiments, and general contents or overlapping contents between the embodiments in the technical field to which the disclosure pertains will be omitted. Terms “unit, module, member, and block” used in the specification may be implemented as software or hardware, and according to the embodiments, a plurality of “units, modules, members, and blocks” may be implemented as one component or one “unit, module, member, and block” may also include a plurality of components.

Throughout the specification, when a certain portion is described as being “connected” to another, this includes not only a case of being directly connected thereto but also a case of being indirectly connected thereto, and the indirect connection includes connection through a wireless communication network.

In addition, when a certain portion is described as “including,” a certain component, this means further including other components rather than precluding other components unless especially stated otherwise.

Throughout the specification, when a certain member is described as being positioned “on” another member, this includes not only a case where the certain member is in contact with another member but also a case where other members are present between the two members.

Terms such as first and second are used to distinguish one component from another, and the components are not limited by the above-described terms. A singular expression includes plural expressions unless the context clearly dictates otherwise.

In each operation, identification symbols are used for convenience of description, and the identification symbols do not describe the sequence of each operation, and each operation may be performed in a different sequence from the specified sequence unless a specific sequence is clearly described in context.

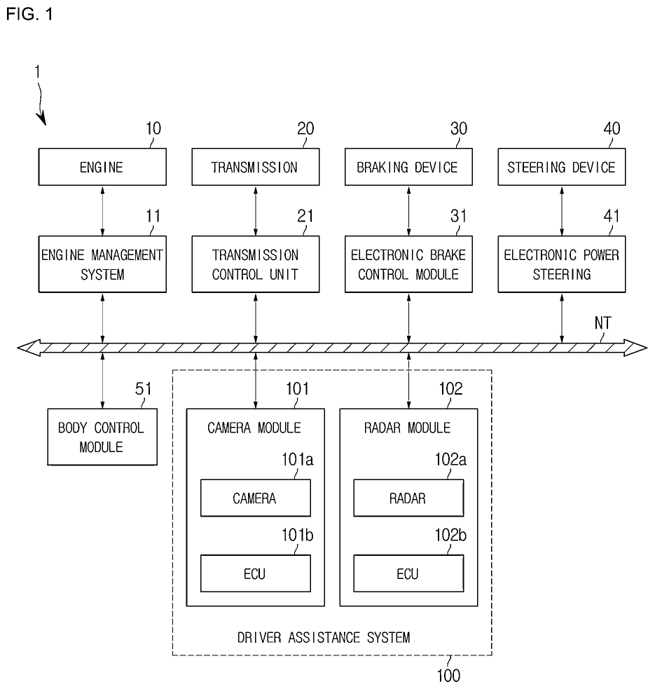

FIG. 1 is a configuration diagram of a vehicle according to an embodiment.

A vehicle 1 according to embodiments of the present disclosure may be a vehicle that performs a manual traveling mode in which a vehicle travels in response to a driver's driving intention and a cruise control mode in which the vehicle travels at a set speed while maintaining a certain distance from another vehicle and may be a vehicle that further performs an autonomous traveling mode in which a vehicle autonomously travels to a destination on the basis of current position information and destination information of the vehicle 1.

The cruise control mode is a mode that allows the vehicle 1 to continuously travel in a state of maintaining a constant speed and has an advantage of allowing a driver to take his/her foot off an accelerator pedal upon long-distance traveling.

The cruise control is also referred to as active cruise control (ACC), adaptive cruise control, smart cruise control (SCC), advanced smart cruise control, or dynamic radar cruise control (DRCC).

The vehicle 1 according to the embodiments of the present disclosure may also be an internal combustion engine vehicle or an eco-friendly vehicle.

In the disclosed embodiments, an example in which a vehicle performs the cruise control mode among internal combustion engine vehicles will be described.

As shown in FIG. 1, the vehicle 1 includes an engine 10, a transmission 20, a braking device 30, and a steering device 40.

The engine 10 may include a cylinder and a piston and generate power for the vehicle 1 to travel.

The transmission 20 may include a plurality of gears and transmit the power generated by the engine 10 to wheels.

The braking device 30 may decelerate the vehicle 1 or stop the vehicle 1 through friction with the wheels.

The steering device 40 may change a traveling direction of the vehicle 1.

The vehicle 1 may include a plurality of electronic components.

For example, the vehicle 1 may further include an engine management system (EMS) 11, a transmission control unit (TCU) 21, an electronic brake control module 31, an electronic power steering (EPS) 41, a body control module (BCM) 51, and a driver assistance system (DAS) 100.

The EMS 11 may control the engine 10 in response to a driver's acceleration intention through an accelerator pedal or a request of the DAS 100. For example, the EMS 11 may control a torque of the engine 10.

The TCU 21 may control the transmission 20 in response to a driver's transmission command through a transmission lever (or also referred to as a gear lever, a shifting lever, or a gear shift) and/or a traveling speed of the vehicle 1. For example, the TCU 21 may adjust a transmission ratio from the engine 10 to the wheels.

The electronic brake control module 31 may control the braking device 30 in response to a driver's braking intention through a brake pedal 33 and/or slip of the wheels. For example, the electronic brake control module 31 may temporarily release the braking of the wheels in response to the slip of the wheels detected upon braking of the vehicle 1 (anti-lock braking systems (ABS)).

The electronic brake control module 31 may selectively release the braking of the wheels in response to oversteering and/or understeering detected upon steering of the vehicle 1 (electronic stability control (ESC)).

In addition, the electronic brake control module 31 may temporarily brake the wheel in response to the slip of the wheels detected upon driving of the vehicle 1 (traction control system (TCS)).

The EPS 41 may assist an operation of the steering device 40 so that the driver may easily operate a steering wheel in response to the driver's steering intention through the steering wheel. For example, the EPS 41 may assist the operation of the steering device 40 to reduce a steering force upon low-speed traveling or parking and increase the steering force upon high-speed traveling.

The BCM 51 may control operations of electronic components for providing convenience to the driver or ensuring the driver's safety. For example, the BCM 51 may control a head lamp, a wiper, a cluster, a multi-function switch, a turn signal light, and the like.

The DAS 100 may assist the driver to operate (driving, braking, and steering) the vehicle 1. For example, the DAS 100 may detect an environment (e.g., other vehicles, pedestrians, cyclists, lanes, and road signs) around the vehicle 1 and control driving, braking, and/or steering of the vehicle 1 in responds to the detected environment.

The DAS 100 may provide various functions to the driver. For example, the DAS 100 may provide lane departure warning (LDW), lane keeping assist (LKA), high beam assist (HBA), automatic emergency braking (AEB), traffic sign recognition (TSR), smart cruise control (SCC), blind spot detection (BSD), and the like.

The DAS 100 may include an autonomous traveling device for allowing the vehicle 1 itself to recognize the road environment, determining obstacles and traveling situations, and controlling the traveling of the vehicle 1 according to a planned traveling route while avoiding the obstacles so that the vehicle 1 automatically travels to the destination.

The DAS 100 includes a camera module 101 for acquiring image data of surroundings of the vehicle 1 and a radar module 102 for acquiring obstacle data of the surroundings of the vehicle 1.

The camera module 101 may include a camera 101a and a controller (ECU) 101b, capture the surroundings of the vehicle 1, and recognize other vehicles, pedestrians, cyclists, lanes, road signs, and the like.

The radar module 102 may include a radar 102a and a controller 102b and acquire a relative position, relative speed, and the like of obstacles (e.g., other vehicles, pedestrians, and cyclists) around the vehicle 1.

The electronic components may communicate with each other via a vehicle communication network (NT). For example, the electronic components may exchange data via Ethernet, media oriented systems transport (MOST), Flexray, controller area network (CAN), local interconnect network (LIN), etc.

The DAS 100 may transmit a driving control signal, a braking control signal, and a steering control signal to the EMS 11, the electronic brake control module 31, and the EPS 41, respectively, via the NT.

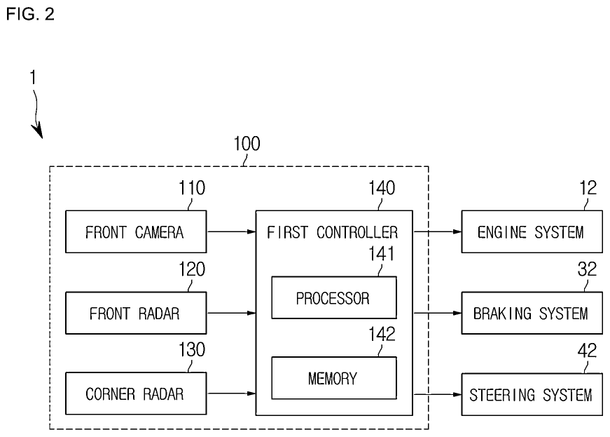

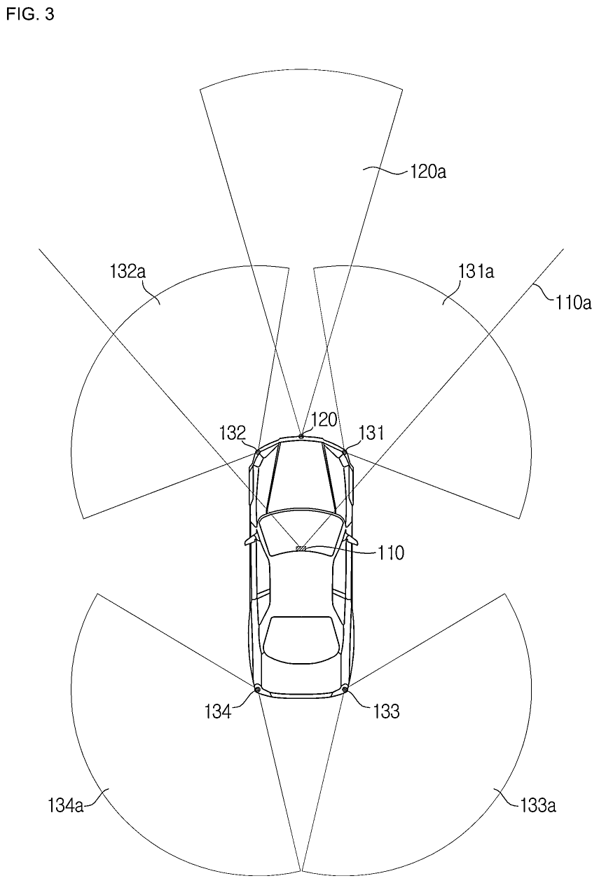

FIG. 2 is a configuration diagram of a driver assistance system provided in the vehicle according to the embodiment, and FIG. 3 is a view schematically showing a camera and radar of the driver assistance system according to the embodiment.

The DAS according to the embodiment may perform a collision avoidance function for avoiding a collision with an obstacle while traveling. At this time, the DAS may control braking to avoid the collision. In other words, the DAS according to the embodiment may be a collision avoidance device and a braking control device.

As shown in FIG. 2, the vehicle 1 may include an engine system 12, a braking system 32, a steering system 42, and the DAS 100.

The engine system 12 may include the EMS 11 (see FIG. 1) described with reference to FIG. 1, the engine 10 (see FIG. 1), the TCU 21 (see FIG. 1), and the transmission 20 (see FIG. 1), the braking system 32 may include the electronic brake control module 31 (see FIG. 1) and the braking device 30 (see FIG. 1), and the steering system 42 may include the EPS 41 (see FIG. 1) and the steering device 40 (see FIG. 1).

The DAS 100 according to the embodiment may include a front camera 110 as a camera of the camera module 101 and a front radar 120 and a plurality of corner radars 130 (131, 132, 133, and 134) as radars of the radar module 102.

As shown in FIG. 3, the DAS 100 may include the front camera 110 for securing a field of view 110a in front of the vehicle 1, the front radar 120, and the plurality of corner radars 130.

The front camera 110 may be installed on a front windshield of the vehicle 1.

The front camera 110 may capture the front of the vehicle 1 and acquire image data of the front of the vehicle 1. The image data of the front of the vehicle 1 may include position information on at least one of another vehicle, pedestrian, cyclist, lane, curb, guardrail, street tree, and streetlight positioned in front of the vehicle 1.

The front camera 110 may include a plurality of lenses and an image sensor. The image sensor may include a plurality of photodiodes for converting light into electrical signals, and the plurality of photodiodes may be disposed in a two-dimensional matrix.

The front camera 110 may be electrically connected to a first controller 140. For example, the front camera 110 may be connected to the first controller 140 via the NT, connected to the first controller 140 via a hard wire, or connected to the first controller 140 via a printed circuit board (PCB).

The front camera 110 may transmit the image data of the front of the vehicle 1 to the first controller 140.

The front radar 120 may have a field of sensing 120a in front of the vehicle 1. The front radar 120 may be installed on, for example, a grille or a bumper of the vehicle 1.

The front radar 120 may include a transmission antenna (or a transmission antenna array) for radiating transmitted radio waves toward the front of the vehicle 1 and a reception antenna (or a reception antenna array) for receiving reflected radio waves reflected by obstacles.

The front radar 120 may acquire front radar data from the transmitted radio waves transmitted by the transmission antenna and the reflected radio waves received by the reception antenna.

The front radar data may include position information and speed information of another vehicle, pedestrian, or cyclist positioned in front of the vehicle 1.

The front radar 120 may calculate the relative distance to the obstacle on the basis of a phase difference (or a time difference) between the transmitted radio wave and the reflected radio wave and calculate a relative speed of the obstacle on the basis of a frequency difference between the transmitted radio wave and the reflected radio wave.

The front radar 120 may be connected to the first controller 140 via, for example, the NT, the hard wire, or the PCB. The front radar 120 may transmit the front radar data to the first controller 140.

The plurality of corner radars 130 include a first corner radar 131 installed on a front right side of the vehicle 1, a second corner radar 132 installed on a front left side of the vehicle 1, a third corner radar 133 installed on a rear right side of the vehicle 1, and a fourth corner radar 134 installed on a rear left side of the vehicle 1.

The first corner radar 131 may have a field of sensing 131a in front right side of the vehicle 1. The first corner radar 131 may be installed on a right side of a front bumper of the vehicle 1.

The second corner radar 132 may have a field of sensing 132a in front left side of the vehicle 1 and may be installed on a left side of the front bumper of the vehicle 1.

The third corner radar 133 may have a field of sensing 133a facing the rear right side of the vehicle 1 and may be installed on a right side of a rear bumper of the vehicle 1.

The fourth corner radar 134 may have a field of sensing 134a facing the rear left side of the vehicle 1 and may be installed on a left side of the rear bumper of the vehicle 1.

Each of the first, second, third, and fourth corner radars 131, 132, 133, and 134 may include the transmission antenna and the reception antenna.

The first, second, third, and fourth corner radars 131, 132, 133, and 134 may acquire first corner radar data, second corner radar data, third corner radar data, and fourth corner radar data, respectively.

The first corner radar data may include distance information and speed information on another vehicle, pedestrian, or cyclist (hereinafter referred to as “obstacle”) positioned on the front right side of the vehicle 1.

The second corner radar data may include distance information and speed information on an obstacle positioned on the front left side of the vehicle 1.

The third and fourth corner radar data may include distance information and speed information on the obstacles positioned on the rear right side of the vehicle 1 and the rear left side of the vehicle 1.

Each of the first, second, third, and fourth corner radars 131, 132, 133, and 134 may be connected to the first controller 140 via the NT, the hard wire, or the PCB.

The first, second, third, and fourth corner radars 131, 132, 133, and 134 may respectively transmit the first, second, third, and fourth corner radar data to the first controller 140.

The first controller 140 may include the controller 101b (see FIG. 1) of the camera module 101 (see FIG. 1), the controller 102b (see FIG. 1) of the radar module 102 (see FIG. 1), and/or a separate integrated controller.

The first controller 140 includes a processor 141 and a memory 142.

The processor 141 may process front image data of the front camera 110, the front radar data of the front radar 120, and the corner radar data of the plurality of corner radars 130 and generate the braking signal and the steering signal for controlling the braking system 32 and the steering system 42.

For example, the processor 141 may include an image signal processor for processing the front image data of the front camera 110, a digital signal processor for processing the radar data of the radars 120 and 130, and/or a micro control unit (MCU) for generating the braking signal and the steering signal.

The processor 141 may detect obstacles (e.g., other vehicles, pedestrians, cyclists, curbs, guardrails, street trees, or streetlights) in front of the vehicle 1 on the basis of the front image data of the front camera 110 and the front radar data of the front radar 120.

Specifically, the processor 141 may acquire position information (distances and directions) and speed information (relative speeds) of the obstacles in front of the vehicle 1 on the basis of the front radar data of the front radar 120. The processor 141 may acquire position information (directions) and type information (e.g., whether the obstacles are other vehicles, pedestrians, cyclists, curbs, guardrails, street trees, or streetlights) of the obstacles in front of the vehicle 1 on the basis of the front image data of the front camera 110.

In addition, the processor 141 may match the obstacles detected by the front image data with the obstacles detected by the front radar data and acquire the type information, the position information, and the speed information of the obstacles in front of the vehicle 1 on the basis of a matching result.

The processor 141 may generate the braking signal and the steering signal on the basis of the type information, the position information, and the speed information of the front obstacles.

For example, the processor 141 may calculate a time to collision (TTC) between the vehicle 1 and the front obstacle on the basis of the position information (relative distances) and speed information (relative speeds) of the front obstacles, and alert the driver of collision, transmit the braking signal to the braking system 32, or the steering signal to the steering system 42 on the basis of a comparison result between the TTC and a predetermined reference time.

The processor 141 may output an alarm through an audio and/or a display in response to a TTC that is shorter than a predetermined first reference time.

The processor 141 may transmit a pre-braking signal to the braking system 32 in response to a TTC that is shorter than a predetermined second reference time.

The processor 141 may transmit an emergency braking signal to the braking system 32 in response to a TTC that is shorter than a predetermined third reference time. At this time, the second reference time is shorter than the first reference time, and the third reference time is shorter than the second reference time.

The processor 141 may transmit the steering signal to the steering system 42 on the basis of direction information among the position information of the front obstacles.

As another example, the processor 141 may calculate a distance to collision (DTC) on the basis of speed information (i.e., relative speeds) of the front obstacles and alert the driver of collision or transmit the braking signal to the braking system 32 on the basis of a comparison result between the DTC and distances to the front obstacles.

The processor 141 may acquire position information (distances and directions) and speed information (relative speeds) of obstacles of the sides (front right side, front left side, rear right side, and rear left side) of the vehicle 1 on the basis of the corner radar data of the plurality of corner radars 130.

The memory 142 may store a program and/or data for processing image data by the processor 141, a program and/or data for processing radar data by the processor 141, and a program and/or data for generating the braking signal and/or the steering signal by the processor 141.

The memory 142 may temporarily store the image data received from the front camera 110 and/or the radar data received from the radars 120 and 130 and temporarily store a processing result of the image data and/or the radar data of the processor 141.

The memory 142 may include non-volatile memories such as flash memory, read only memory (ROM), and erasable programmable ROM (EPROM) as well as volatile memories such as SRAM and DRAM.

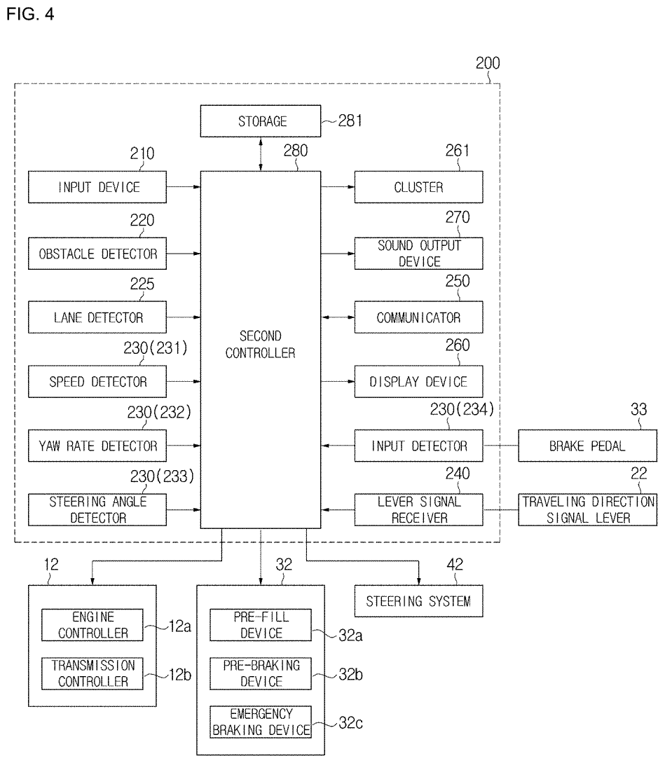

FIG. 4 is a configuration diagram of a cruise control device of the driver assistance system provided in the vehicle according to the embodiment.

In addition, the cruise control device may be a second controller and may also communicate with an input device 210, an obstacle detector 220, a lane detector 225, a traveling information detector 230, a lever signal receiver 240, a communicator 250, a display device 260, a cluster 261, a sound output device 270, and a storage 281.

A cruise control device 200 of the DAS 100 may include the input device 210, the obstacle detector 220, the lane detector 225, the traveling information detector 230, the lever signal receiver 240, the communicator 250, the display device 260, the cluster 261, the sound output device 270, a second controller 280, and the storage 281 and further include the engine system 12, the braking system 32, and the steering system 42.

The input device 210 receives a user input.

The input device 210 may receive an ON command and an OFF command of the cruise control mode and transmit a signal corresponding to the received command to the second controller 280.

The input device 210 may receive an operation command for any one of functions that may be performed in the vehicle 1. For example, the input device 210 may receive an operation command of at least one of a radio function, an audio function, a video function, a map display function, a navigation function, a DMB function, a content playback function, and an Internet search function.

The input device 210 may also receive a target traveling speed for performing the cruise control mode.

The input device 210 may receive an ON command and an OFF command of a collision risk notification mode that indicates the possibility of collision with an obstacle.

The input device 210 may be provided on a head unit or a center fascia in the vehicle 1 or may also be provided on a vehicle terminal. The input device 210 may be provided as a button, a key, a switch, an operation lever, a jog dial, etc. or may also be provided as a touch pad.

The obstacle detector 220 detects obstacles of the front and left and right sides of the vehicle 1 and transmits obstacle information about the detected obstacles to the second controller 280. Here, the obstacle information may include position information of the obstacle, and the position information of the obstacle may include distance information and direction information of the obstacle. The distance information on the distance to the obstacle may be distance information on the relative distance to the obstacle.

The obstacle detector 220 may include the front radar 120, the first and second corner radars 131 and 132 and may further include the front camera.

In addition, the obstacle detector 220 may also include a light detection and ranging (LiDAR) sensor. The LiDAR sensor is a non-contact type distance detection sensor using a laser radar principle. The LiDAR sensor may include a transmitter for transmitting a laser and a receiver for receiving the laser that is reflected from a surface of an object present within a range of the sensor and returned.

The obstacle detector 220 may also include an ultrasonic sensor.

The ultrasonic sensor generates ultrasonic waves for a predetermined time and then detects a signal that is reflected from the object and returned. The ultrasonic sensor may be used to determine the presence or absence of an obstacle, such as a pedestrian, within a near field range.

The obstacle detector 220 may also detect an obstacle behind the vehicle 1.

The lane detector 225 detects lanes around the vehicle 1 and transmits lane information on the detected lanes to the second controller 280. Here, the lane information may include position information of left and right lanes of a lane on which the vehicle 1 travels, and the position information of the lane may include distance information to the lane and direction information of the lane. The distance information to the lane may include distance information between the vehicle 1 and the left lane and distance information between the vehicle 1 and the right lane.

The lane detector 225 may include the front camera 110.

The vehicle 1 may include a traveling information detector 230 for detecting traveling information of the vehicle 1, such as traveling speed information, traveling direction information, yaw rate information, deceleration information, and acceleration information. In other words, the traveling information detector 230 may include a speed detector 231, a yaw rate detector 232, a steering angle detector 233, and a pressure detector 234.

The speed detector 231 may include a plurality of wheel speed sensors. The speed detector 231 may include an acceleration sensor. The speed detector 231 may include the plurality of wheel speed sensors and the acceleration sensor.

When the speed detector 231 includes the acceleration sensor, the second controller 280 may acquire the acceleration of the vehicle 1 on the basis of the information detected by the acceleration sensor and also acquire the traveling speed of the vehicle 1 on the basis of the acquired acceleration.

When the speed detector 231 includes the acceleration sensor and the plurality of wheel speed sensors, the second controller 280 may acquire the acceleration of the vehicle 1 on the basis of the information detected by the acceleration sensor and also acquire the traveling speed of the vehicle 1 on the basis of the speed information acquired by the plurality of wheel speed sensors.

The yaw rate detector 232 detects a yaw moment of the vehicle 1. The yaw rate detector 232 detects a turning angular speed, which is a yaw rate in a direction of a vertical axis of the vehicle 1.

The yaw rate detector 232 may be provided on a body of the vehicle 1 and may be provided on a lower portion of a center console or a driver's seat, but is not limited to these positions.

A steering wheel for adjusting the traveling direction, a brake pedal 33 pressed by the user according to the user's (i.e., the driver's) braking intention, and an accelerator pedal pressed by the user according to the user's acceleration intention may be included inside the vehicle 1, and a traveling direction signal lever 22 provided around the steering wheel and indicating turning directions of a left turn, a right turn, and a U-turn may be further included inside the vehicle 1.

The steering angle detector 233 detects an angular speed of the steering wheel for detecting the steering angle of the vehicle 1. In other words, the steering angle detector 233 may include an angular speed detector.

The pressure detector 234 detects a pressure applied to the brake pedal 33.

The vehicle 1 may further include a pressure detector for detecting a pressure applied to an accelerator pedal (i.e., an acceleration pedal).

The lever signal receiver 240 receives a lever signal corresponding to an operation direction of the traveling direction signal lever 22 and transmits the received lever signal to the second controller 280.

The lever signal corresponding to the operation direction may include a lever signal for the left turn and a lever signal for the right turn.

The vehicle 1 may further include a lamp signal receiver (not shown) for receiving a signal of a traveling direction indication lamp that is turned on or off in response to an operation of the traveling direction signal lever.

In other words, the traveling direction signal lever 22 may be connected to a left turn signal lamp and a right turn signal lamp to turn on the left turn signal lamp in response to an operation corresponding to the left turn and turn on a right turn signal lamp in response to an operation corresponding to the right turn.

The traveling direction signal lamp may be turned on and off on the basis of navigation information and current position information according to the command of the second controller 280.

The communicator 250 may communicate with other nearby vehicles, and at this time, receive at least one of identification information, current position information, traveling route information, destination information, and traveling speed information on another vehicle and transmit at least one of identification information, the current position information, traveling route information, destination information, and the traveling speed information on the vehicle 1 to another vehicle.

The display device 260 displays operation information on a function being performed. For example, the display device 260 may display information related to a phone call, display content information output through a terminal (not shown), display information related to music playback, and display external broadcasting information.

The display device 260 may display map information, and may also display map information and road guidance information in which a route to a destination is matched. The display device 260 may also display information on going straight, a left turn, a right turn, and a U-turn.

The display device 260 may display ON information and OFF information of the cruise control mode and display ON/OFF information of the collision risk notification mode.

The display device 260 may display an image of a road or also display position information on a pedestrian and position information on another vehicle.

The display device 260 may display collision risk information notifying a collision with an obstacle as an image.

The display device 260 may also display the deceleration information and the steering information for obstacle avoidance as images.

The display device 260 may also display deceleration guidance information and steering guidance information for avoiding a collision with another vehicle as an image.

The display device 260 may display an image or turn on and off lamps in response to a control command of the second controller 280.

The display device 260 may be a lamp, such as a light emitting diode (LED) or a flat panel display device, such as a liquid crystal display (LCD).

The display device 260 may be a display panel to be provided on the vehicle terminal.

The display device 260 may include the cluster 261 provided in the vehicle 1.

The cluster 261 may include a lamp indicating the collision risk information. The cluster 261 may turn on or off the lamp in response to the control command of the second controller 280.

The cluster 261 may display an image for the collision risk information.

The cluster 261 may include a tachometer, a speedometer, a coolant temperature gauge, a fuel gauge, a turn signal lamp, a high beam indicator lamp, a warning lamp, a seat belt warning lamp, an odometer, an odometer, a transmission lever indicator lamp, a door open warning lamp, an engine oil warning lamp, a low fuel warning lamp, etc.

The sound output device 270 outputs sound in response to the control command of the second controller 280 and outputs the sound at a level corresponding to the control command of the second controller 280.

The sound output device 270 may output warning information as the sound to notify the risk of the collision with the obstacle. The sound output device 270 may be one speaker or two or more speakers.

The sound output device 270 may also output a sound requesting deceleration to avoid a collision with another front vehicle.

The second controller 280 performs the cruise control mode when an ON signal for the ON command of the cruise control mode is received through the input device 210.

When performing the cruise control mode, the second controller 280 may control the vehicle 1 to travel at a preset target traveling speed or the vehicle 1 to travel at a target traveling speed input by the user, control deceleration or acceleration on the basis of the obstacle information detected by the obstacle detector 220, and control the output of the collision risk information.

Here, the collision risk information may or may not be output depending on whether the collision risk notification mode is selected by the user.

When it is determined that there is no obstacle in front of the vehicle 1 on the basis of the obstacle information detected by the obstacle detector 220 while the cruise control mode is performed, the second controller 280 may control the vehicle 1 to travel at the target traveling speed on the basis of the traveling speed information detected by the speed detector 231.

The second controller 280 may control acceleration or deceleration on the basis of traveling information on another vehicle that travels around the traveling route of the vehicle 1 while performing the cruise control mode.

The second controller 280 may acquire relative distance information and relative speed information of another vehicle on the basis of the obstacle information detected by the obstacle detector 220 while performing the cruise control mode, acquire a first target deceleration on the basis of the acquired relative speed information and relative speed information of another vehicle, and control braking on the basis of the first target deceleration.

The second controller 280 may also control braking on the basis of obstacle information on obstacles that are present on the traveling route of the vehicle 1 among the information received by the communicator 250. Here, the obstacle information may be information on obstacles other than other vehicles, such as falling rocks, pedestrians, bicycles, and barricades.

While performing the cruise control mode, the second controller 280 may control acceleration on the basis of the obstacle information detected by the obstacle detector 220, the target traveling speed input through the input device 210, the traveling speed information detected by the speed detector 231, and the lever signal received by the lever signal receiver 240 and control the maintenance of the cruise control mode.

When controlling the acceleration, the second controller 280 may control an operation of any one of an engine controller 12a and a transmission controller 12b of the engine system 12 on the basis of preset cruise control acceleration. The preset cruise control acceleration may be determined on the basis of the target traveling speed or determined on the basis of a difference between the target traveling speed and the current traveling speed.

While performing the cruise control mode, the second controller 280 may control the output of the deceleration request information on the basis of the obstacle information detected by the obstacle detector 220, the target traveling speed input through the input device 210, the traveling speed information detected by the speed detector 231, and the lever signal received by the lever signal receiver 240 and control the release of the cruise control mode on the basis of the pressure information detected by the pressure detector 234.

The second controller 280 may also determine whether the traveling direction is changed on the basis of the steering angle information detected by the steering angle detector 233 or the yaw rate information detected by the yaw rate detector 232 and also determine whether the traveling direction is changed on the basis of the difference in wheel speeds. Here, the change in the traveling direction may include a change in a traveling lane.

While performing the cruise control mode, the second controller 280 may control the output of the deceleration request information on the basis of whether the traveling direction is changed.

While performing the cruise control mode, the second controller 280 may determine the traveling direction on the basis of the navigation information, control the output of the deceleration request information when the determined traveling direction is a direction of a left turn, a right turn, or a U-turn, and control the release of the cruise control mode on the basis of the pressure information detected by the pressure detector 234.

When controlling braking, the second controller 280 may control an operation of any one of a pre-fill device 32a, a pre-braking device 32b, and an emergency braking device 32c in the braking system 32 on the basis of the TTC with another vehicle or the relative distance information of another vehicle.

For example, the second controller 280 may control the operation of any one of the pre-fill device 32a, the pre-braking device 32b, and the emergency braking device 32c on the basis of first, second, and third braking distances and the relative distance information of another vehicle.

The first braking distance is a braking distance at which the pre-fill device 32a is controlled, the second braking distance is a braking distance at which the pre-braking device 32b is controlled, and the third braking distance is a braking distance at which the emergency braking device 32c is controlled, and each may be a preset braking distance.

A configuration of the second controller 280 provided in the cruise control device will be described below in detail with reference to a flowchart.

The second controller 280 may also be implemented as a single processor.

The second controller 280 may be implemented as a memory (not shown) for storing data for an algorithm for controlling the operations of the components in the vehicle 1 and a program reproducing the algorithm and a processor (not shown) for performing the above-described operations using the data stored in the memory. In this case, each of the memory and the processor may be implemented as a separate chip. Alternatively, the memory and the processor may also be implemented as a single chip.

The storage 281 may store map information and road information.

The map information may include position information on roads, position information on buildings around the roads, etc. The road information may include position information on street trees, position information of buildings, loading information such as construction goods, position information on banners, etc around intersections or roads on which a left turn, a right turn, and a U-turn are available.

The storage 281 may store information on the target traveling speed.

The storage 281 may store a program and/or data for processing the radar data, a program and/or data for processing the radar data, and a program and/or data for the second controller 280 to generate the braking signal and/or the warning signal.

The storage 281 may temporarily store the image data received from the front camera 110 and/or the radar data received from the radars 120 and 130 and temporarily store processing results of the image data and/or the radar data of the storage 281.

The storage 281 may also store information on the preset braking distance for each braking device of the braking system.

More specifically, the storage 281 may store information on the first braking distance of the pre-fill device, the second braking distance of the pre-braking device, and the third braking distance of the emergency braking device.

The storage 281 may store information on type and level information on sound corresponding to the warning of the risk of collision.

The storage 281 may be implemented as at least one of non-volatile memory devices, such as a cache, a read only memory (ROM), a programmable ROM (PROM), an erasable programmable ROM (EPROM), an electrically erasable programmable ROM (EEPROM), and a flash memory, volatile memory devices, such as a random access memory (RAM), a hard disk drive (HDD), or a storage medium, such as a CD-ROM, but is not limited thereto.

The storage 281 may be a memory implemented as a separate chip from the above-described processor related to the second controller 280 or may also be implemented as a single chip with the processor.

The cruise control mode is performed by the cruise control device as follows. Hereinafter, the operation or control of the vehicle 1 may be performed by an operation of control of the second controller 280 of the cruise control device provided in the vehicle 1 or another component of the cruise control device.

When the vehicle 1 receives the destination information through the input device 210 while performing the cruise control mode, the vehicle 1 may search for a route from the current position to the destination on the basis of the current position information and the destination information acquired by the position receiver, generate navigation information by matching route information on the searched route with map information, and output a navigation image and road guidance information on the basis of the generated navigation information.

When performing a navigation mode, the vehicle 1 may search for a route on the basis of road environment information received through the communicator and also match route information on the searched route with the map information.

The vehicle 1 may acquire the current position information on the basis of the position information received by the position receiver while traveling in the cruise control mode and control the output of the navigation information according to traveling on the basis of the acquired current position information. When performing the navigation mode, the vehicle 1 may acquire traveling route information on the traveling route of the vehicle 1 on the basis of the navigation information.

The vehicle 1 may acquire the traveling speed of the vehicle 1 on the basis of a plurality of wheel speeds detected by a plurality of wheel speed sensors, acquire the traveling speed of the vehicle 1 on the basis of the acceleration detected by the acceleration sensor, and acquire actual traveling speed information of the vehicle 1 on the basis of the plurality of wheel speeds detected by the plurality of wheel speed sensors and the acceleration detected by the acceleration sensor.

The vehicle 1 may control acceleration and deceleration on the basis of the target traveling speed information and the actual traveling speed information when performing the cruise control mode and control the deceleration or the acceleration on the basis of the obstacle information detected by the obstacle detector 220. Here, the obstacle may be other vehicles that travel in front of the vehicle 1 and may further include obstacles, which are present on the road, other than other vehicles.

The vehicle 1 may control the output of the collision risk information on the basis of the obstacle information. Here, the collision risk information may or may not be output depending on whether the collision risk notification mode is selected by the user.

More specifically, the vehicle 1 may recognize another vehicle that travels within the traveling route of the vehicle 1 on the basis of the obstacle information detected by the obstacle detector 220. For example, the vehicle 1 may identify a following target vehicle, which is another vehicle, on the basis of the obstacle information detected by the front radar.

The vehicle 1 may travel while following the following target vehicle on the basis of the obstacle information detected by the obstacle detector 220 when performing the cruise control mode. Here, the following traveling is performed in a state in which the distance to the following target vehicle is maintained at a predetermined distance.

At this time, the vehicle 1 may acquire relative distance information of the following target vehicle in front of the vehicle 1 on the basis of the distance information of the following target vehicle.

In addition, the vehicle 1 may recognize the following target vehicle that travels in front of the vehicle 1 on the basis of the image information acquired by the front camera 110 and also acquire relative distance information and relative speed information of the following target vehicle recognized by the front camera on the basis of the obstacle information detected by the obstacle detector 220.

The vehicle 1 may acquire the relative speed information of the following target vehicle on the basis of the acquired relative distance information of the following target vehicle and the traveling speed information of the vehicle 1. In other words, the vehicle 1 may check a change in the relative distance information of the following target vehicle over time and acquire the relative speed with the following target vehicle on the basis of the changed relative distance information and the traveling speed information of the vehicle 1.

The vehicle 1 may acquire the TTC with the following target vehicle on the basis of the relative distance information and the relative speed information of the following target vehicle in front of the vehicle 1 and notify the driver of the risk of collision or control braking on the basis of the comparison result between the TTC and the predetermined reference time.

The vehicle 1 may control the output of the collision risk information through at least one of the sound output device and the display device in response to the TTC that is shorter than the predetermined first reference time.

The vehicle 1 may control braking in response to the TTC that is shorter than the predetermined second reference time. Here, the second reference time may be shorter than the first reference time.

In other words, the vehicle 1 may control the operation of at least one of the display device and the sound output device to output the collision risk information when the collision time of the following target vehicle is shorter than or equal to the first reference time and exceeds the second reference time and control the braking for collision avoidance control when the collision time of the following target vehicle is shorter than or equal to the second reference time.

As another example, the vehicle 1 may acquire the DTC of the following target vehicle on the basis of the relative speed information of the following target vehicle in front of the vehicle 1 and notify the risk of collision of the driver or control braking on the basis of the comparison result between the DTC and the distance to the following target vehicle.

In other words, the vehicle 1 may control the operation of at least one of the display device and the sound output device to output the collision risk information when the distance to the following target vehicle is a first reference distance and control the braking for collision avoidance when the distance to the following target vehicle is a second reference distance. Here, the second reference distance may be shorter than the first reference distance. The first and second reference distances may be pre-stored information.

When it is determined that the vehicle 1 may not avoid a collision by braking, the vehicle 1 may acquire the direction of the following target vehicle and also output guidance information on the traveling direction of the vehicle 1 for collision avoidance on the basis of the acquired direction of the following target vehicle.

As described above, the vehicle 1 may travel while following a following target vehicle 2 while performing the cruise control mode and travel while avoiding the collision with the following target vehicle.

The vehicle 1 may accelerate to travel at the target traveling speed when the following target vehicle may not be identified due to reasons such as a change in a traveling lane of the following target vehicle while traveling.

At this time, when the vehicle 1 travels in a different direction from the following target vehicle in front of the vehicle 1, such as when turning at an intersection, or when the following target vehicle is not identified due to the change in the traveling direction of the vehicle 1, an acceleration value may increase when a difference between the actual traveling speed and the target traveling speed of the current vehicle 1 is large, thereby causing the collision with another vehicle in front of the vehicle 1 or the obstacle and increasing the driver's anxiety due to acceleration.

In addition, when the vehicle 1 accelerates, the driver performs braking when the vehicle 1 is out of a speed suitable for turning or when another obstacle is present in front of the vehicle 1. As described above, when the driver perform the braking, the cruise control is released, and when the traveling is in a safe state thereafter, the driver needs to set the cruise control mode again.

Therefore, the DAS according to the embodiment of the present disclosure may acquire a yaw rate value and a yaw acceleration value on the basis of the yaw rate information of the vehicle 1 while the cruise control mode is performed, determine whether the vehicle 1 is in a turning state on the basis of the acquired yaw rate value and yaw acceleration value and the detected lane information, and control the acceleration of the vehicle 1 on the basis of the obstacle information and the actual traveling speed information.

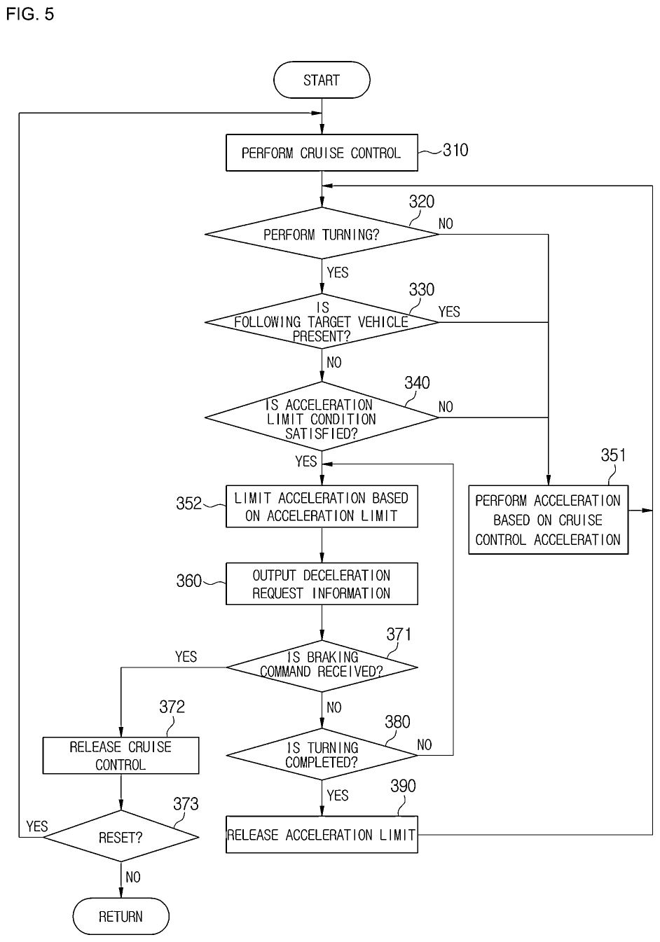

FIG. 5 is a vehicle control flowchart of the driver assistance system according to the embodiment.

In the present disclosure, as described above, the vehicle 1 may acquire the actual traveling speed of the vehicle 1 on the basis of the plurality of wheel speeds detected by the plurality of wheel speed sensors when performing the cruise control mode, acquire the actual traveling speed of the vehicle 1 on the basis of the acceleration detected by the acceleration sensor, and acquire the actual traveling speed information of the vehicle 1 on the basis of the plurality of wheel speeds detected by the plurality of wheel speed sensors and the acceleration detected by the acceleration sensor.

When performing the cruise control mode, the vehicle 1 travels while controlling acceleration and deceleration so that the actual traveling speed reaches the target traveling speed on the basis of the target traveling speed information and the actual traveling speed information.

The vehicle 1 may control deceleration or acceleration on the basis of the obstacle information detected by the obstacle detector 220. In other words, the vehicle 1 determines whether the following target vehicle that travels in front of the vehicle 1 is present on the basis of the obstacle information detected by the obstacle detector 220, controls the traveling of the vehicle 1 at the target traveling speed when it is determined that the following target vehicle is not present, and follows the following target vehicle when it is determined that the following target vehicle is present.

At this time, the vehicle 1 acquires the relative distance information of the following target vehicle on the basis of the obstacle information detected by the obstacle detector and travels while adjusting the traveling speed on the basis of the acquired relative distance information of the following target vehicle and the actual traveling speed information of the vehicle 1.

The vehicle 1 acquires the yaw rate value and the yaw acceleration value on the basis of the yaw rate information while performing the cruise control (310) and determines whether the vehicle 1 is in the turning state on the basis of the acquired yaw value and yaw acceleration value and the detected lane information (320). When it is determined that the vehicle 1 is not in the turning state (No in 320), the vehicle 1 travels while decelerating or accelerating on the basis of the acceleration (traveling or following at the target traveling speed) by the cruise control mode as described above (351). A detailed method of determining whether the vehicle 1 is in the turning state will be described below.

When it is determined that the vehicle 1 is in the turning state (Yes in 320), the vehicle 1 determines whether the following target vehicle is present around the vehicle 1 on the basis of the obstacle information of the obstacle detector 220 (330). When it is determined that the following target vehicle is present (Yes in 330), the vehicle 1 travels while decelerating or accelerating on the basis of the acceleration (following) by the cruise control mode (351).

When it is determined that the vehicle 1 is in the turning state and the following target vehicle is not present around the vehicle 1 (No in 330), the vehicle 1 determines whether an acceleration limit condition is satisfied on the basis of the traveling speed information (340).

When it is determined that the acceleration limit condition is satisfied (Yes in 340), the vehicle 1 controls acceleration on the basis of an acceleration limit (352), and when it is determined that the acceleration limit condition is not satisfied (No in 340), the vehicle 1 travels while decelerating or accelerating on the basis of the acceleration (traveling at the target traveling speed) by the cruise control mode as described above (351).

In the embodiments of the present disclosure, the acceleration limit condition may include a condition in which the traveling speed of the vehicle 1 exceeds a first reference traveling speed and is lower than a second reference traveling speed. Even when the actual traveling speed of the vehicle 1 is very low (lower than the second reference traveling speed) and the acceleration of the vehicle 1 is limited, a traffic flow may also be disturbed by the vehicle 1, and the driver may also feel stuffy. Conversely, when the speed of the vehicle 1 is very high (exceeds the first reference traveling speed), it is not possible to prevent an accident upon turning only by limiting the acceleration of the vehicle 1. Since the possibility of a collision upon turning increases in a case in which the driver relies only on the cruise control when the speed of the vehicle is high, in the embodiments of the present disclosure, the vehicle 1 may guide the driver to press a brake to decelerate without limiting acceleration.

As shown in FIG. 5, the vehicle 1 determines whether it is in the turning state (320), determines whether the following target vehicle is present around the vehicle 1 on the basis of the obstacle information when it is determined that the vehicle 1 is in the turning state (330), determines whether the acceleration limit condition is satisfied when it is determined that the following target vehicle is not present around the vehicle 1 (340), and controls the acceleration on the basis of the acceleration limit when it is determined that the acceleration limit condition is satisfied (352). Therefore, when the vehicle 1 is in the turning state, the following target vehicle is not present, and the acceleration limit condition is satisfied, the vehicle 1 may perform acceleration control on the basis of the acceleration limit rather than the current cruise control acceleration, thereby preventing sudden acceleration upon turning.

At this time, the acceleration limit may be determined on the basis of a difference between the speed of the vehicle 1 and the speed of another vehicle that travels around the vehicle 1 detected on the basis of the obstacle information. Here, another vehicle is a vehicle that travels around the vehicle 1 rather than the following target vehicle. In other words, since the acceleration limit is determined on the basis of the difference between the speed of another vehicle and the current speed of the vehicle 1, the vehicle 1 may travel without interfering with the flow of nearby vehicles. Here, the nearby may include a front, and the speed of another vehicle may be a longitudinal speed of another vehicle. In one embodiment, the acceleration limit may be determined as a value obtained by multiplying a difference between the speed of another vehicle and the speed of the vehicle 1 by a predetermined conversion coefficient.

Meanwhile, when another vehicle that travels around the vehicle 1 is not detected or when the speed of another vehicle is lower than the current speed of the vehicle 1, the acceleration limit may be 0 m/s².

When performing acceleration limit control, the vehicle 1 outputs the deceleration request information requesting deceleration to the user (360). At this time, the deceleration request information may be output through at least one of the display device, the cluster, and the sound output device.

The vehicle 1 may determine whether the braking command is received while turning (371).

When it is determined that the braking command has been received while turning, the vehicle 1 controls deceleration and releases the cruise control mode (372).

In other words, the vehicle 1 may control the release of the cruise control mode when receiving the pressure information corresponding to the pressing of the brake pedal 33 through the pressure detector 234.

Thereafter, the vehicle 1 performs a manual driving mode before the cruise control mode is reset by the user and performs the cruise control mode when the cruise control mode is reset while performing the manual driving mode (373).

The vehicle 1 determines whether the turning has been completed on the basis of the yaw rate information while performing the cruise control mode (380) and releases the acceleration limit control when it is determined that the turning has been completed (Yes in 380). Thereafter, the vehicle 1 continues to travel in the cruise control mode.

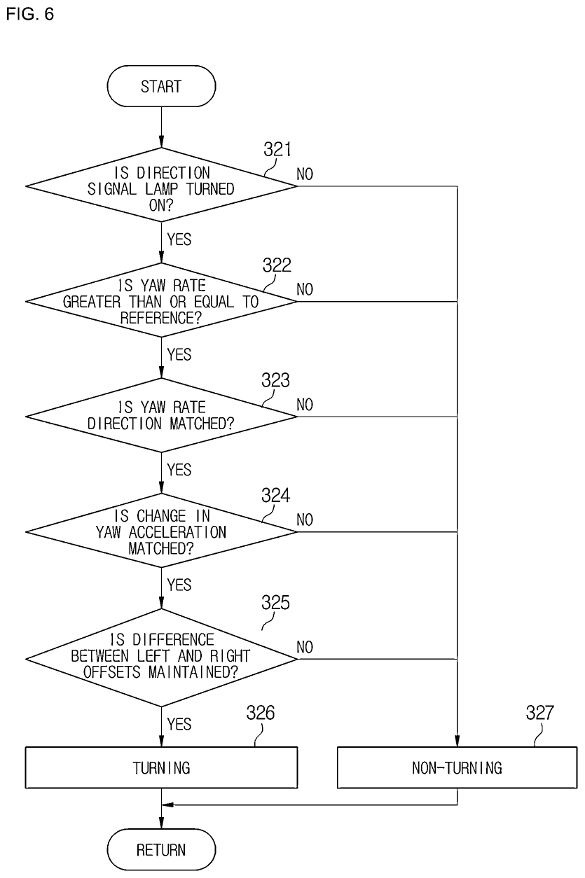

FIG. 6 is a vehicle control flowchart of the driver assistance system according to the embodiment and is a vehicle control flowchart when determining whether the vehicle is in a turning state.

Referring to FIG. 6, a detailed method of determining whether the vehicle 1 is in the turning state 320 may be confirmed.

The vehicle 1 may acquire the yaw rate value and the yaw acceleration value on the basis of the yaw rate information while performing the cruise control (310) and determine whether the vehicle 1 is in the turning state on the basis of the acquired yaw rate value and yaw acceleration value and the detected lane information (320).

Referring to FIG. 6, the vehicle 1 determines whether the vehicle 1 is in the turning state on the basis of whether the turning command has been received through the lever signal receiver 240 (321). When not receiving the turning command (No in 321), the vehicle 1 determines that the vehicle 1 is not in the turning state (327) and proceeds to the next determination (322) when the turning driving command is received (Yes in 321).

At this time, the vehicle 1 may determine that the turning command has been received when it is determined that any one traveling direction signal lamp has been turned on and determine that an emergency lamp has been turned on when it is determined that two traveling direction signal lamps have been both turned on.

When it is determined that the turning command is received (Yes in 321), the vehicle 1 determines whether the vehicle 1 is in the turning state on the basis of the yaw rate value detected by the yaw rate detector 232 (322).

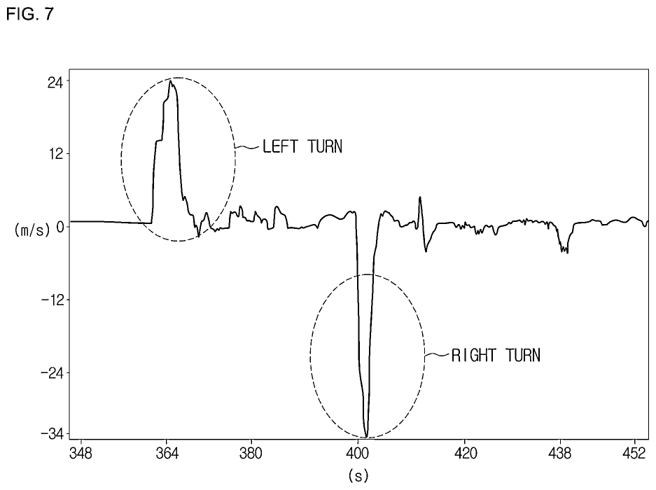

As shown in FIG. 7, when the vehicle 1 makes a left turn, a positive yaw rate value is output, and when the vehicle 1 makes a right turn, a negative yaw rate value is output. When a magnitude of the yaw rate value is smaller than a preset reference value (No in 322), the vehicle 1 determines that the vehicle 1 is not in the turning state (327) and proceeds to the next determination (323) when the magnitude of the yaw rate value is greater than or equal to the reference value (Yes in 322). When the vehicle 1 turns, a non-zero yaw rate value is output, but since the yaw rate value detected by the yaw rate detector 232 includes noise, only when the magnitude of the yaw rate value, that is, an absolute value of the yaw rate vale, is greater than or equal to the preset reference value, it may be determined that the vehicle 1 is in the turning state.

When it is determined that the magnitude of the yaw rate value is greater than or equal to the reference value (Yes in 322), the vehicle 1 determines whether the vehicle 1 is in the turning state on the basis of the sign of the yaw rate value detected by the yaw rate detector 232 (323). As shown in FIG. 7, a sign of the yaw rate value varies depending on the traveling direction of the vehicle 1. Therefore, when a turning direction determined according to the sign of the yaw rate value and a direction of the received turning command do not match (No in 323), the vehicle 1 determines that the vehicle 1 is not in the turning state (327) and proceeds to the next determination (324) when the turning direction matches the direction of the turning command (Yes in 323).

When it is determined that the turning direction determined according to the sign of the yaw rate value matches the turning command (Yes in 323), the vehicle 1 determines whether the vehicle 1 is in the turning state on the basis of the yaw acceleration detected by the yaw rate detector 232 (324). As shown in FIG. 7, since the yaw rate varies, the vehicle 1 may determine whether the yaw acceleration corresponding to a differential value of the yaw rate value is changed from a positive value to a negative value or the yaw acceleration is changed from the negative value to the positive value and determine whether the vehicle 1 makes a left turn or a right turn. Therefore, when the turning direction determined according to the change in the sign of the yaw acceleration and the direction of the received turning command do not match (No in 324), the vehicle 1 determines that the vehicle 1 is not in the turning state (327) and proceeds to the next determination (325) when the turning direction matches the direction of the turning command (Yes in 324).

When it is determined that the turning direction determined according to the change in the sign of the yaw acceleration matches the turning command (Yes in 324), the vehicle 1 derives a first offset between the vehicle 1 and the left lane and a second offset between the vehicle 1 and the right lane on the basis of the detected lane information and determines whether the vehicle 1 is in the turning state on the basis of a difference between the first offset and the second offset (325).

The vehicle 1 may not be in the turning state even when the turning command is received and the yaw rate value, the sign of the yaw rate, and the change in the sign of the yaw acceleration match references. For example, even when the vehicle 1 makes a U-turn or the vehicle 1 changes a lane, the vehicle 1 may receive the turning command through the lever signal receiver 240 as in the turning state, and the changes in the yaw rate value, the sign of the yaw rate, and the sign of the yaw acceleration may appear similar to those upon turning. In the present disclosure, it is possible to increase the accuracy of the determination by determining whether the vehicle 1 turns on the basis of the lane information detected by the lane detector 255.

When the vehicle 1 makes a U-turn or changes a lane, the difference between the first offset between the vehicle 1 and the left lane and the second offset between the vehicle 1 and the right lane changes rapidly because the vehicle 1 travels across the lane.

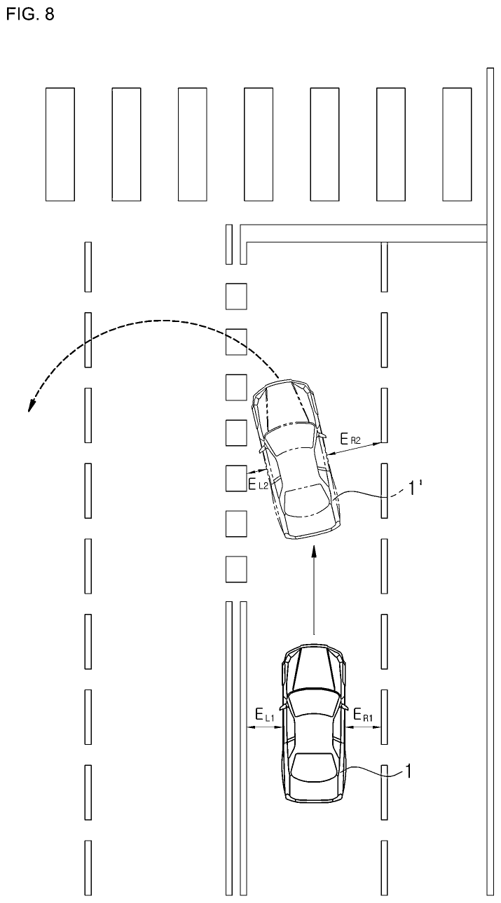

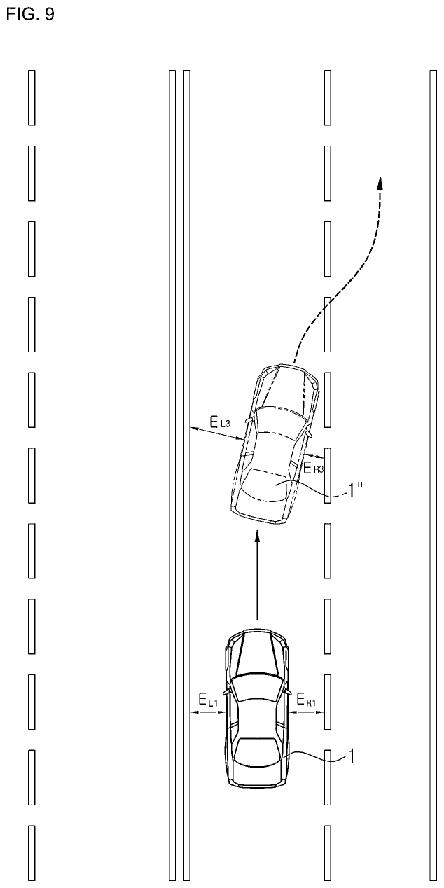

FIGS. 8 and 9 are exemplary views of road environments when the vehicle according to the embodiment travels in the cruise control mode.

FIG. 8 shows a traveling state of the vehicle 1 that makes a U-turn. When the vehicle 1 travels along the traveling lane (indicated by a solid line), a first offset E_{L1} between the vehicle 1 and the left lane and a second offset E_{R1} between the vehicle 1 and the right lane are maintained almost equally.

Then, when the vehicle 1 becomes the vehicle 1′ turning to make the U-turn, a first offset E_{L2} decreases, and a second offset E_{R2} increases, and thus a difference between the first offset and the second offset increases.

FIG. 9 shows a traveling state of the vehicle 1 that changes a lane. Likewise, when the vehicle 1 travels along the traveling lane (indicated by a solid line), the first offset E_{L1} between the vehicle 1 and the left lane and the second offset E_{R1} between the vehicle 1 and the right lane are maintained almost equally.

Then, when the vehicle 1 turns to change the lane 1″, a first offset E_{L3} increases and a second offset E_{R3} decreases, and thus a difference between the first offset and the second offset increases.

On the other hand, since the vehicle 1 making the left turn or the right turn at the intersection travels along the traveling lane, then enters the intersection, and turns only after the lane disappears, the difference between the first offset and the second offset is maintained.

Therefore, the vehicle 1 may determine whether the vehicle 1 turns on the basis of the difference between the first offset between the vehicle 1 and the left lane and the second offset between the vehicle 1 and the right lane. When the difference between the first offset and the second offset is out of a predetermined range, the vehicle 1 may determine that the vehicle 1 is not in the turning state. Since it is difficult for the vehicle 1 to travel while maintaining the center of the lane, it is determined that the vehicle 1 does not make the U-turn or change the lane when the difference between the first offset and the second offset is maintained within the predetermined range.

In other words, when the difference between the first offset and the second offset is out of the predetermined range (No in 325), the vehicle 1 determines that the vehicle 1 is not in the turning state (327) and determines that the vehicle 1 is in the turning state (326) when the difference between the first offset and the second offset is maintained within the predetermined range (Yes in 325).

As described above, when the vehicle 1 receives the turning command, the yaw rate value, the sign of the yaw rate, and the change in the sign of the yaw acceleration match the references, and the offsets with the left and right lanes of the vehicle 1 are maintained, the vehicle 1 may determine that the vehicle 1 is in the turning state and determine that the vehicle 1 is not in the turning state in other cases.

According to the embodiments of the present disclosure, it is possible to solve the problem that the traffic flow may be disturbed and the driver may feel stuffy when acceleration is limited when the vehicle 1 turns at low speed, and conversely, when the acceleration is limited at high speed, the possibility of accidents increases.

In addition, it is possible to perform safe traveling by guiding the driver to decelerate when the vehicle makes the left turn or the right turn while the driver relies on the cruise control mode.

Conventionally, when the vehicle intends to make the left turn or the right turn at the intersection, the vehicle accelerates when the following target vehicle in front of the vehicle disappears, and thus the driver's anxiety may increase. In addition, conventionally, when the difference between the actual traveling speed and the target traveling speed of the current vehicle is large, the acceleration value may increase, thereby increasing the risk of front collision.

Therefore, according to the present disclosure, it is possible to limit the acceleration of the vehicle in such a situation, thereby giving a sense of psychological stability to the driver and reducing the possibility of collision with the front vehicle.

As is apparent from the above description, it is possible to limit acceleration in left turn, right turn, and U-turn situations while a cruise control mode is performed, thereby relieving a driver's anxiety due to the sudden acceleration of a host vehicle in response to changes in traveling routes of other vehicles around the host vehicle.

It is possible to increase the accuracy of determination by determining traveling states, such as a left turn, a right turn, and a U-turn, on the basis of various determination factors.

When a speed of the host vehicle is low, acceleration is not limited so that the movement of nearby vehicles is not disturbed and the driver does not feel stuffy.

As described above, the disclosed embodiments have been described with reference to the accompanying drawings. Those skilled in the art to which the present disclosure pertains will understand that the present disclosure can be practiced in a form different from the disclosed embodiments even without changing the technical spirit or essential features of the present disclosure. The disclosed embodiments are illustrative and should not be construed as limiting.

What is claimed is:

1. A driver assistance system comprising:
an obstacle detector configured to detect a nearby obstacle and output obstacle information on the detected obstacle;
a lane detector configured to detect a nearby lane and output lane information on the detected lane;
a speed detector configured to detect a traveling speed of a vehicle and output actual traveling speed information on the detected traveling speed;
a yaw rate detector configured to detect a yaw rate of the vehicle and output yaw rate information on the detected yaw rate; and
a controller configured to acquire a yaw rate value and a yaw acceleration value on the basis of the yaw rate information while performing a cruise control, determine whether the vehicle is in a turning state on the basis of the acquired yaw rate value and yaw acceleration value and the detected lane information, and control acceleration of the vehicle on the basis of the obstacle information and the actual traveling speed information when it is determined that the vehicle is in the turning state.

2. The driver assistance system of claim 1, wherein the controller derives each of a first offset between the vehicle and a left lane and a second offset between the vehicle and a right lane on the basis of the detected lane information, and determines whether the vehicle is in the turning state on the basis of a difference between the first offset and the second offset.

3. The driver assistance system of claim 1, wherein the controller determines whether a following target vehicle is present around the vehicle on the basis of the obstacle information, and when it is determined that the following target vehicle is not present around the vehicle, controls acceleration after whether an acceleration limit condition is satisfied is determined on the basis of the traveling speed information.

4. The driver assistance system of claim 3, wherein the acceleration limit condition includes a condition in which the traveling speed of the vehicle exceeds a first reference traveling speed and is lower than a second reference traveling speed.

5. The driver assistance system of claim 3, wherein the controller controls acceleration on the basis of an acceleration limit when it is determined that the acceleration limit condition is satisfied, and controls the acceleration on the basis of preset cruise control acceleration when it is determined that the acceleration limit condition is not satisfied.

6. The driver assistance system of claim 5, wherein the acceleration limit is determined on the basis of a difference between a speed of the vehicle and a speed of another vehicle that travels around the vehicle detected on the basis of the obstacle information.

7. The driver assistance system of claim 1, further comprising a lever signal receiver configured to receive a lever signal of a traveling direction signal lever,
wherein the controller further determines whether the vehicle is in the turning state on the basis of whether a turning command is received through the lever signal receiver.

8. The driver assistance system of claim 7, wherein the controller determines that the turning command has been received when it is determined that any one traveling direction signal lamp has been turned on, and determines that an emergency lamp has been turned on when it is determined that two traveling direction signal lamps have been both turned on.

9. The driver assistance system of claim 1, wherein the controller controls at least one of a display device, a cluster, and a sound output device to output deceleration request information when controlling the acceleration of the vehicle.

10. The driver assistance system of claim 1, wherein the controller controls release of a cruise control mode upon receiving pressure information corresponding to pressing of a brake pedal.

11. A driver assistance method comprising:
acquiring a yaw rate value and a yaw acceleration value on the basis of yaw rate information detected by a yaw rate detector of a vehicle while a cruise control is performed;
determining whether the vehicle is in a turning state on the basis of the acquired yaw rate value and yaw acceleration value and lane information detected by a lane detector of the vehicle; and
controlling acceleration of the vehicle on the basis of obstacle information detected by an obstacle detector of the vehicle and actual traveling speed information of the vehicle detected by a speed detector of the vehicle when it is determined that the vehicle is in the turning state.

12. The driver assistance method of claim 11, wherein the determining of whether the vehicle is in the turning state includes deriving each of a first offset between the vehicle and a left lane and a second offset between the vehicle and a right lane on the basis of the detected lane information and determining whether the vehicle is in the turning state on the basis of a difference between the first offset and the second offset.

13. The driver assistance method of claim 11, wherein the controlling of the acceleration of the vehicle includes determining whether a following target vehicle is present around the vehicle on the basis of the obstacle information and, when it is determined that the following target vehicle is not present around the vehicle, controlling the acceleration of the vehicle after whether an acceleration limit condition is satisfied is determined on the basis of the traveling speed information.

14. The driver assistance method of claim 13, wherein the acceleration limit condition includes a condition in which a traveling speed of the vehicle exceeds a first reference traveling speed and is lower than a second reference traveling speed.

15. The driver assistance method of claim 13, wherein the controlling of the acceleration of the vehicle includes controlling the acceleration on the basis of an acceleration limit when it is determined that the acceleration limit condition is satisfied and controlling the acceleration on the basis of preset cruise control acceleration when it is determined that the acceleration limit condition is not satisfied.

16. The driver assistance method of claim 15, wherein the acceleration limit is determined on the basis of a difference between a speed of the vehicle and a speed of another vehicle that travels around the vehicle detected on the basis of the obstacle information.

17. The driver assistance method of claim 11, wherein the determining of whether the vehicle is in the turning state further includes determining whether the vehicle is in the turning state on the basis of whether a turning command has been received through a lever signal receiver configured to receive a lever signal of a traveling direction signal lever.

18. The driver assistance method of claim 17, wherein the determining of whether the vehicle is in the turning state includes determining that the turning command has been received when it is determined that any one traveling direction signal lamp has been turned on and determining that an emergency lamp has been turned on when it is determined that two traveling direction signal lamps have been both turned on.

19. The driver assistance method of claim 11, wherein the controlling of the acceleration of the vehicle includes controlling at least one of a display device, a cluster, and a sound output device to output deceleration request information when controlling the acceleration of the vehicle.

20. The driver assistance method of claim 11, further comprising controlling release of a cruise control mode when pressure information corresponding to pressing of a brake pedal is received.
